(19) United States
(12) Patent Application Publication
(10) Pub. No.: US 2003/0066167 A1
(43) Pub. Date: Apr. 10, 2003

(54) FASTENING STRUCTURE OF A HANDLE AND WORKING PART OF A TOOL

(76) Inventor: Yu-Hsin Huang, Chang Hua Hsien (TW)

Correspondence Address: Harrison & Egbert, 7th Floor, 412 Main St., Houston, TX, 77002, US

(21) Appl. No.: 09/973,164

(22) Filed: Oct. 9, 2001

(51) Int. Cl. E05B 1/00

(52) U.S. Cl. 16/430

(57) ABSTRACT

A structure is designed to fasten detachably the handle and the working part of a hand tool. The structure comprises a fastening base located at one end of the handle, a fastening end located at one end of the working part, and a fastening device. The fastening end is detachably fastened with the fastening base in conjunction with the fastening device. As the fastening device is turned such that two planar surfaces of the fastening device are aligned with two side walls of an open end of the retaining hole of the fastening end of the working part, the fastening device can be moved out of the retaining hole so as to enable the handle and the working part to separate from each other.

### BACKGROUND OF THE INVENTION

1. Field of the Invention

The present invention relates generally to a hand tool, and more particularly to a structure for fastening detachably the handle and the working part of the hand tool.

2. Description of Related Art

The conventional hand tools, such as rake, spade, hoe, etc., comprise a handle, and a working part which is fastened undetachably with the handle. As a result, when the handle or working part of the hand tool is damaged, the hand tool is discarded in its entirety, thereby resulting in a waste of material resource as well as an increase in garbage. In addition, the conventional hand tools take up a relatively large storage space.

### BRIEF SUMMARY OF THE INVENTION

The primary objective of the present invention is to provide a structure for fastening detachably the handle and the working part of a hand tool.

It is another objective of, the present invention to provide a hand tool with a handle which can be interchangeably fastened with various working parts.

The foregoing objectives of the present invention are achieved by a structure comprising a handle, a fastening device, and a working part. The handle and the working part are provided at one end thereof with a fastening means by which the handle and the working part are fastened detachably in conjunction with the fastening device.

The foregoing objectives, features and functiohs of the present invention will be more readily understood upon a thoughtful deliberation of the following detailed description of the present invention with reference to the accompanying drawings.

### BRIEF DESCIPTION OF THE SEVERAL VIEWS OF THE DRAWINGS

FIG. 1 shows a perspective of a hand tool of the pres invention.

FIG. 2 shows an exploded view of the hand tool of the present invention as show in FIG. 1.

FIG. 3 shows a sectional view of a fastening structur present invention.

FIG. 4 shows a schematic view of a mechanism by which the handle and the working part of the present invention are detachably fastened together.

FIGS. 5-7 are schematic views to show that the handle of the present invention is interchangeably fastened with the working parts of different kinds.

FIG. 8 shows a schematic view of the way by which the handle and various working parts of the present invention are independently held by a rack.

### DETAILED DESCRIPTION OF THE INVENTION

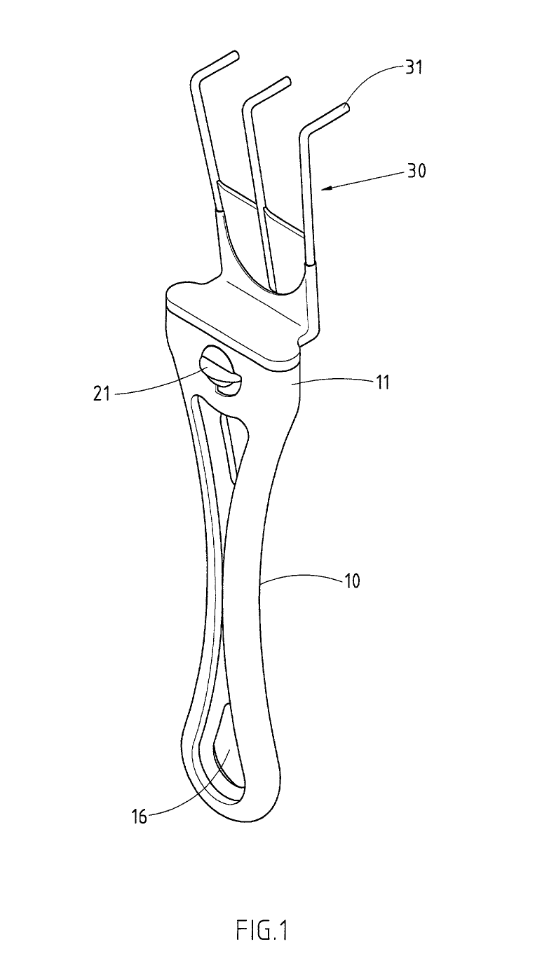

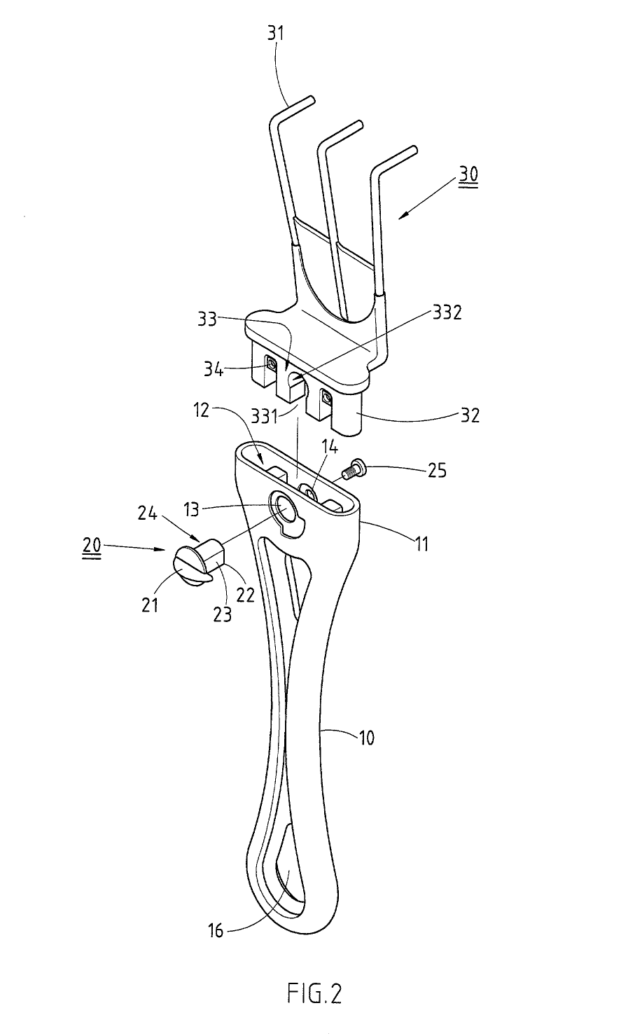

As shown in FIGS. 1-4,, a hand tool embodied in the present invention comprises a handle 10 and a working part 30, which are detachably fastened together end to end by a fastening structure.

The present invention is characterized by the fastening structure, which comprises a fastening base 11 of the handle 10, a fastening end 32 of the working part 30, and a fastening device 20.

The fastening base 11 of the handle 10 is provided with a receiving slot 12, a pivoting hole 13, and a through hole 14 opposite in location to and smaller in diameter than the pivoting hole 13.

The fastening end 32 of the working part 30 is fitted into the receiving slot 12 of the fastening base 11 of the handle 10 and is provided with a retaining hole 33 corresponding in location to the pivoting hole 13 of the fastening base 11 of the handle 10. The retaining hole 33 is provided with an open end 331 and an inner portion 332 greater in hole diameter than the open end 331. The working part 3 0 has a ftinctional portion 31.

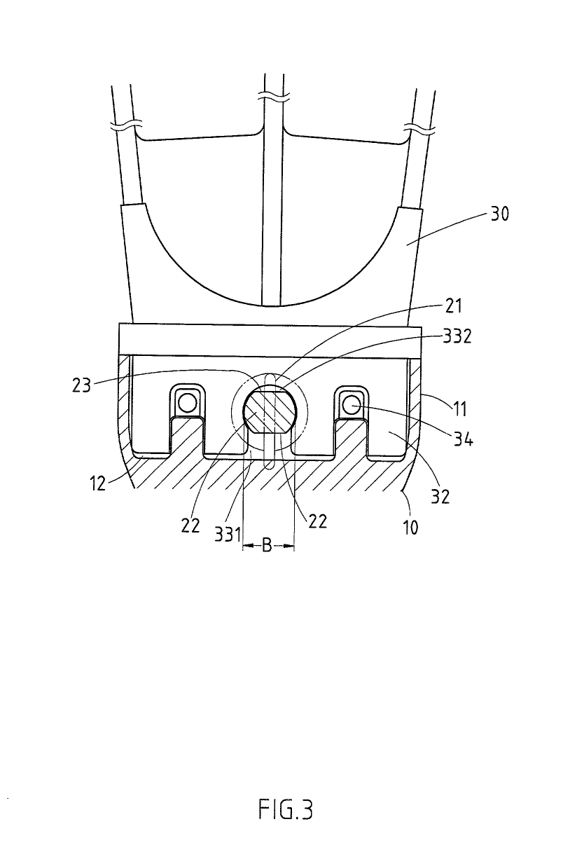

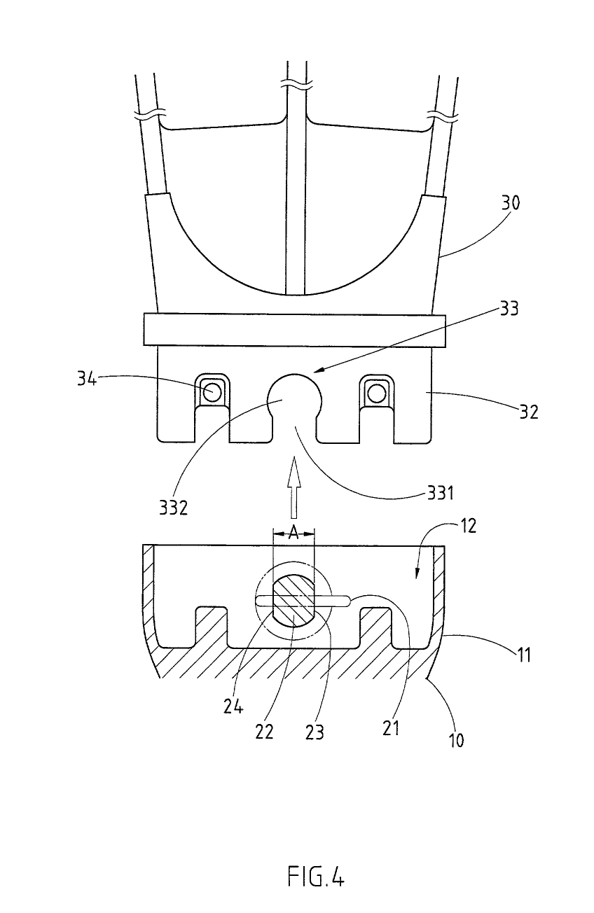

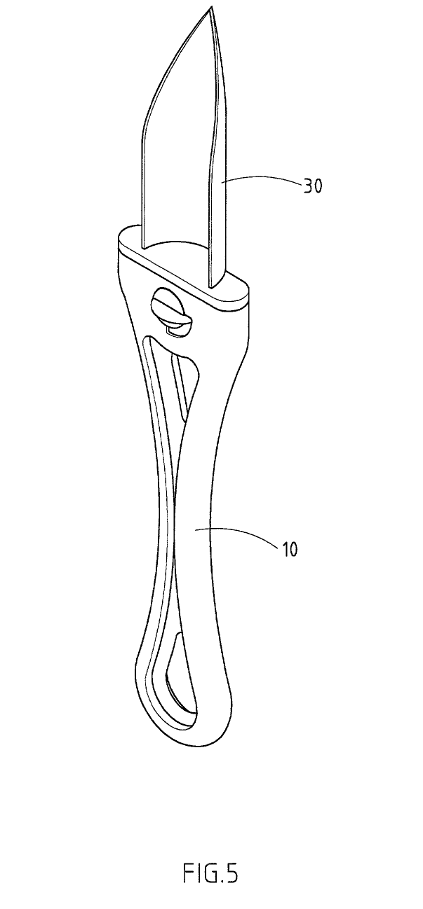

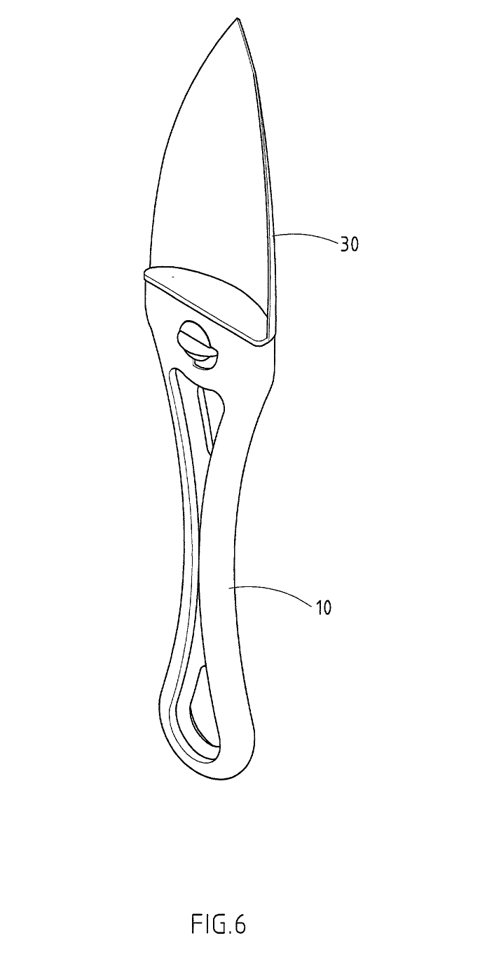

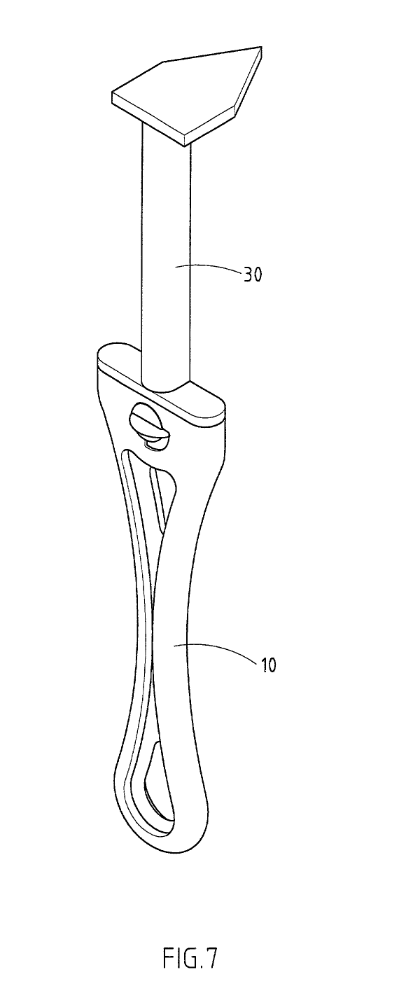

The fastening device 20 comprises a rotary bolt 21 and a screw 25. The rotary bolt 21 has a locating shank 22 which is provided at one end with a threaded hole (not shown in the drawing) engageable with the screw 25. The shank 22 is further provided with two planar surfaces 23 and 24, which are opposite in location to each other and are extended along the longitudinal direction of the shank 22. The two planar surfaces 23 and 24 of the locating shank 22 are separated from each other by a distance “A” which is slightly smaller than the horizontal width “B” of the locating shank 22, as shown in FIGS. 3 and 4.

In combination, the fastening end 32 of the working part 30 is fastened detachably with the fastening base 11 of the handle 10 by the fastening device 20 such that the locating shank 22 of the rotary bolt 21 of the fastening device 20 is received in the retaining hole 33 via the pivoting hole 13 of the fastening base 11, and that the screw 25 is engaged with the threaded hole of the locating shank 22 via the through hole 14 of the fastening base 11 of the handle 10. As shown in FIG. 4, when the two planar surfaces 23 and 24 of the locating shank 22 are aligned with the two opposite side walls of the open end 331 of the retaining hole 33, the locating shank 22 can be put into the inner portion 332 of the retaining hole 33. As the rotary bolt 21 is turned such that the two planar surfaces 23 and 24 of the locating shank 22 of the rotary bolt 21 are no longer aligned with the side walls of the open end 331 of the retaining hole 33, the fastening end 32 of the working part 30 is securely retained by the locating shank 22 of the rotary bolt 2 1, as shown in FIG. 3. The handle 10 and the working part 30 are thus fastened together end to end by the fastening device 20. The handle 10 and the working part 30 are unfastened by turning the rotary bolt 21 such that the two planar surfaces 23 and 24 of the locating shank 22 of the rotary bolt 21 are aligned with the two sidewalls of the open end 331 of the retaining hole 33, so as to enable the locating shank 22 of the rotary bolt 21 to be pulled out of the retaining hole 3 3 via the open end 331.

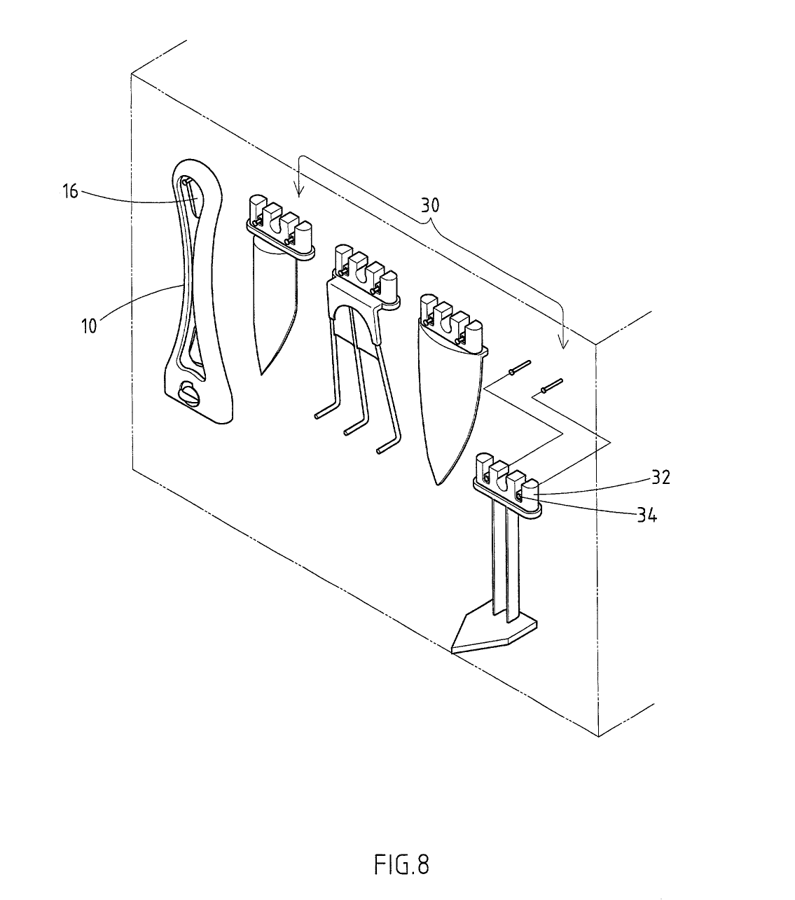

The handle 10 is provided at a tail end with a hanging hole 16 to facilitate the hanging of the handle 10 by a tool rack, as illustrated in FIG. 8. Similarly, the fastening end 32 of the working part 30 is provided with one or more hanging holes 34 by means of which the working part 30 is held on to the tool rack, as illustrated in FIG. 8.

The present invention described above is to be regarded in all respects as being merely illustrative and nonrestrictive. Accordingly, the present invention may be embodied in other specific forms without deviating from the spirit thereof. The present invention is therefore to be limited only by the scopes of the following claims.

I claim:

1. A structure for fastening detachably the handle and the working part of a hand tool, said structure comprising:
a fastening base located at one end of the handle and provided with a receiving slot, a pivoting hole, and a through hole opposite in location to said pivoting hole and smaller in diameter than said pivoting hole;
a fastening end located at one end of the working part and provided with a retaining hole corresponding in location to said pivoting hole of said fastening base of the handle, said retaining hole being provided with an ope n end and an inner portion greater in diameter than said open end; and
a fastening device comprising a rotary bolt and a screw, said rotary bolt provided at one end with a threaded hole engageable with said screw, said rotary bolt having a locating shank which is provided with two planar surfaces opposite in location to each other such that said two planar surfaces are separated from each other by a distance smaller than a horizontal width of said locating shank;
said fastening end of the working part being fastened detachably with said fastening base of the handle in conjunction with said fastening device such that said fastening end of the working part is fitted into said receiving slot of said fastening base of the handle, and that said locating shank of said rotary bolt is received in said inner portion of said retaining hole of said fastening end of the working part via said pivoting hole of said fastening base of the handle, and further that said two planar surfaces of said locating shank are not aligned with two side walls of said open end of said retaining hole of said fastening end of the working part whereby said locating shank of said rotary bolt can be moved out said inner portion of said retaining hole by turning said rotary bolt in such a manner that said two planar surfaces of said locating shank are aligned with said two side walls of said open end of said retaining hole of said fastening end of the working part, thereby resulting in separation of the working part from the handle.

2. The structure for fastening detachably the handle and the working part of a hand tool as defined in claim 1. wherein the tail end of the handle is provided with a hanging hole.

3. The structure for fastening detachably the handle and the working part of a hand tool as defined in claim 1, wherein the fastening end of the working part is provided with one or more hanging holes.
